(19) United States
(12) Patent Application Publication
(10) Pub. No.: US 2023/0188925 A1
(43) Pub. Date: Jun. 15, 2023

(54) NETWORK NODE, USER EQUIPMENT AND METHODS PERFORMED THEREIN FOR COMMUNICATION IN A WIRELESS COMMUNICATION NETWORK

(71) Applicant: Telefonaktiebolaget LM Ericsson (publ), Stockholm (SE)

(72) Inventors: Badawi Yamine, Beirut (LB); Iana Siomina, Täby (SE)

(21) Appl. No.: 17/924,136

(22) PCT Filed: May 12, 2020
(86) PCT No.: PCT/SE2020/050484

§ 371 Date: Nov. 9, 2022

(51) Int. Cl. H04W 4/02

(52) U.S. Cl. CPC H04W 4/023

(57) ABSTRACT

A method performed by a network node for enabling notifications to User Equipment users. The network node detects that an event associated with a non-radio degradation has occurred in a radio coverage area served by the network node. The network node then stores information about the detected event in a server, wherein the information comprises at least a location of the event. The network node then transmits an indication of the event, wherein the indication indicates that said information is available in the server.

### TECHNICAL FIELD

Embodiments herein relate to a network node, a user equipment and methods performed therein. In particular, embodiments herein relate to handling communication in a wireless communication network.

### BACKGROUND

In a typical wireless communication network, user equipment (UE), also known as wireless communication devices, mobile stations, stations (STA) and/or wireless devices, communicate via a Radio Access Network (RAN) with one or more core networks belonging to different network operators. The RAN covers a geographical area which is divided into areas or cell areas, with each area or cell area being served by a radio network node, e.g., a Wi-Fi access point or a Radio Base Station (RBS), which in some networks may also be called, for example, a NodeB, eNodeB or a gNodeB. The area or cell area is a geographical area where radio coverage is provided by the radio network node. The radio network node communicates over an air interface operating on radio frequencies with the UE within range of the radio network node.

A Universal Mobile Telecommunications System (UMTS) is a third generation telecommunication network, which evolved from the second generation (2G) Global System for Mobile Communications (GSM). The UMTS Terrestrial Radio Access Network (UTRAN) is essentially a RAN using Wideband Code Division Multiple Access (WCDMA) and/or High Speed Packet Access (HSPA) for user equipment. In a forum known as the Third Generation Partnership Project (3GPP), telecommunications suppliers propose and agree upon standards for third generation networks and UTRAN specifically, and investigate enhanced data rate and radio capacity. In some RANs, e.g. as in UMTS, several radio network nodes may be connected, e.g., by landlines or microwave, to a controller node, such as a Radio Network Controller (RNC) or a Base Station Controller (BSC), which supervises and coordinates various activities of the plural radio network nodes connected thereto. The RNCs are typically connected to one or more core networks.

Specifications for the Evolved Packet System (EPS) have been completed within the 3GPP and this work continues in the coming 3GPP releases. The EPS comprises the Evolved Universal Terrestrial Radio Access Network (E-UTRAN), also known as the Long Term Evolution (LTE) radio access network, and the Evolved Packet Core (EPC), also known as System Architecture Evolution (SAE) core network. E-UTRAN/LTE is a variant of a 3GPP radio access technology wherein the radio network nodes are directly connected to the EPC core network rather than to RNCs. In general, in E-UTRAN/LTE the functions of an RNC are distributed between the radio network nodes, e.g. eNodeBs in LTE, and the core network. As such, the RAN of an EPS has an essentially “flat” architecture comprising radio network nodes which can be connected directly to one or more core networks, i.e. they do not need to be connected to the core via RNCs.

With the emerging 5G technologies such as New Radio (NR), the use of a large number of transmit- and receive-antenna elements is of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals coming from a selected direction or directions, while suppressing unwanted signals coming from other directions.

The term “network node”, is used herein to represent any node of a wireless network that is operative to communicate signals and messages with wireless devices. The network node in this disclosure may include a base station, radio node, Node B, base transceiver station, access point, etc., although this disclosure is not limited to these examples. The network node in this disclosure may also include a communication control node in the wireless network, such as a Radio Network Controller, RNC, or a core network node, that controls one or more base stations or radio nodes that communicate radio signals with wireless devices.

In this disclosure, the term “non-radio degradation” is used to denote a state or situation with a local impact that potentially affects humans in the area such as UE users, and which is not related to a radio environment. It is assumed herein that UE users potentially want to avoid entering an area where some kind of non-radio degradation occurs, which will be exemplified below, and that it is desirable to get a notification or “warning” on the UE from the network regarding the non-radio degradation. An area or location where non-radio degradation occurs may be referred to as “location X” for short, while the current location of a wireless device is sometimes referred to as “location L”.

Events associated with non-radio degradation may comprise one or more of: a fire, an earthquake, any hazardous gas, e.g. methane or CO2 or others, a traffic jam, a local destruction, quarantine or health-related or health-threatening events or conditions, an area with high-risk of virus or decease spreading. Degradation handling may be triggered when measurement of one of such non-radio degradation events meets a pre-determined condition, e.g. exceeds or falls below a certain threshold, or remains active for a predefined period of time.

In prior art, a notification about an event related to non-radio degradation is broadcasted to all UEs in the cell, which is unnecessary for the UEs and is also wasting system resources when the degradation has a local impact.

### SUMMARY

An object of embodiments herein is to provide a mechanism that handles communication in a more efficient manner.

According to an aspect the object is achieved by providing a method performed by a network node for enabling notifications to UE users. The network node detects that an event associated with a non-radio degradation has occurred in a radio coverage area served by the network node, wherein the UE users potentially want to avoid said event. The network node further stores information about the detected event in a server. The information comprises at least a location of the event. The network node then transmits an indication of the event. The indication indicates that said information is available in the server.

According to another aspect the object is achieved by providing a method performed by a UE for enabling notifications to UE users. The UE receives an indication of an event, associated with a non-radio degradation, which the UE users potentially want to avoid. The indication indicates that information about the event is available in a server. The UE further retrieves the information about the event from the server. The information comprises at least a location of the event. The UE further obtains a position of the UE. The UE then notifies the users of the UE about the event if the obtained UE position is within a pre-determined distance from the location of the event.

According to yet another aspect the object is achieved by providing a network node for enabling notifications to UE users. The network node is configured to detect that an event associated with a non-radio degradation has occurred in a radio coverage area served by the network node, wherein the UE users potentially want to avoid said event. The network node is further configured to store information about the detected event in a server. The information comprises at least a location of the event. The network node is further configured to transmit an indication of the event. The indication indicates that said information is available in the server.

According to still another aspect the object is achieved by providing a UE for enabling notifications to UE users. The UE is configured to receive an indication of an event, associated with a non-radio degradation, which the UE users potentially want to avoid. The indication indicates that information about the event is available in a server. The UE is further configured to retrieve the information about the event from the server. The information comprises at least a location of the event. The UE is further configured to obtain a position of the UE. The UE is further configured to notify the UE users about the event if the obtained UE position is within a pre-determined distance from the location of the event.

It is furthermore provided herein a computer program product comprising instructions, which, when executed on at least one processor, cause the at least one processor to carry out the method above, as performed by the network node or the UE. It is additionally provided herein a computer-readable storage medium, having stored thereon a computer program product comprising instructions which, when executed on at least one processor, cause the at least one processor to carry out the method according to the method above, as performed by the network node or the UE.

Embodiments herein are based on the realisation that it is unnecessary to notify all UEs in a cell about an event associated with non-radio degradation as it wastes system resources and therefore only the UE users that are close to the event are notified. Accordingly the network node detects that a non-degradation event has occurred, stores information about the event in a server and transmits an indication of the event, the UE can retrieve the information about the event from the server and the UE can notify the user of the UE about the event if the obtained UE position is within a pre-determined distance from the location of the event. Only the UE users close to the event are notified about the event and thereby the communication is handled in a more efficient manner and the power consumption of the UE is decreased.

### BRIEF DESCRIPTION OF THE DRAWINGS

Examples of embodiments herein are described in more detail with reference to attached drawings in which:

FIG. 1 is a schematic communication scenario illustrating embodiments of a wireless communications network;

FIG. 2 is a combined signaling scheme and flowchart depicting embodiments herein;

FIG. 3 is a flowchart depicting a method performed by a network node according to embodiments herein;

FIG. 4 is a flowchart depicting a method performed by a UE according to embodiments herein;

FIG. 5 is a flowchart illustrating an example of how some embodiments herein may be used;

FIG. 6 is a schematic block diagram illustrating a network node according to some embodiments herein;

FIG. 7 is a schematic block diagram illustrating a UE according to some embodiments herein;

FIG. 8 illustrates a telecommunication network connected via an intermediate network to a host computer in accordance with some embodiments;

FIG. 9 illustrates a host computer communicating via a base station with a user equipment over a partially wireless connection in accordance with some embodiments;

FIG. 10 illustrates methods implemented in a communication system including a host computer, a base station and a user equipment in accordance with some embodiments;

FIG. 11 illustrates methods implemented in a communication system including a host computer, a base station and a user equipment in accordance with some embodiments;

FIG. 12 illustrates methods implemented in a communication system including a host computer, a base station and a user equipment in accordance with some embodiments; and

FIG. 13 illustrates methods implemented in a communication system including a host computer, a base station and a user equipment in accordance with some embodiments.

### DETAILED DESCRIPTION

In the context of this disclosure, the terms “subscriber” and “UE user” are used and can be regarded as synonyms. As part of developing embodiments herein, some problems related to non-radio degradation have been identified and will be discussed below:

It has been recognized that information about a non-radio degradation may be irrelevant or at least unnecessary for UE users which are not within or close to an area of degradation, i.e. close to the occurrence of an event associated with non-radio degradation. In the case that a non-radio degradation event, e.g. a fire in a flat or a traffic jam in a particular road occurs, all UEs, and hence their subscribers, located in the cell are notified when conventional procedures are used. This is however often not efficient as a subscriber, e.g. a UE user, located far away from a building should not need to be notified about a fire in the building. Similarly, a subscriber on a first road, or sitting at his desk, should not need to be notified about a traffic jam on a second far away road. Hence, there is a need for a network function that notifies only the subscribers that may be affected by the degradation, e.g. subscribers located within or close to the area of degradation. Otherwise, the information may be disturbing other UE users which do not need this information.

Sending the location X of the degradation area to all UEs, i.e. also to UEs in idle mode, e.g. in a cell or group of cells, is also not efficient. Encoding a location such as X may use a large number of data bits that must be broadcasted and thus wasting precious system broadcast resources. Sending information about X to all UEs may also force all the UEs to trigger a power-consuming positioning operation to get their location L and compare it to the location X in order to determine whether the UE is close to location X or not and take appropriate precaution. Broadcasting to all UEs may be avoided for UEs in active mode by using dedicated signaling but the above problem remains, unless the network determines itself whether each active UE is close to the degradation area. Hence, there is currently no efficient solution for informing idle UEs about X and there is still no UE-based solution for UEs in active mode.

Furthermore, there is no solution to show the subscribers the details of degradation for UEs in idle mode in case only UEs close to the degradation are notified. In prior art, there is already a procedure to send the notification of the degradation to all UEs in a cell, e.g. via Short Message Service (SMS). In that way the subscriber could read the notification.

However, in order to achieve that the notification of the degradation should reach only some selected UEs, particularly those which are close to the degradation so that their users could in some way potentially be affected thereby, then:
For UEs in connected mode, this is possible as in prior art, there are different options available to locate the UE. In one option, the network could be used to estimate a location of the UE as it is exchanging some dedicated signaling message with the UE. In another option as the UE is in connected mode, the network may send a notification to the UEs close to location of degradation via the application layer.
For UEs in idle mode there is no such procedure available. In fact, the UE in idle mode is not connected to the network in any way. In prior art the only existing solution is to reach all UEs in idle mode and not only some specific ones. In another possible scenario, in case of broadcasting location X to all UEs in idle mode so that each UE compares its own location L with location X, then the problem described above may be encountered. As there is no efficient way in prior art to reach particular UEs in idle mode then consequently there is no solution to show the notification of degradation for some particular UEs in idle mode.

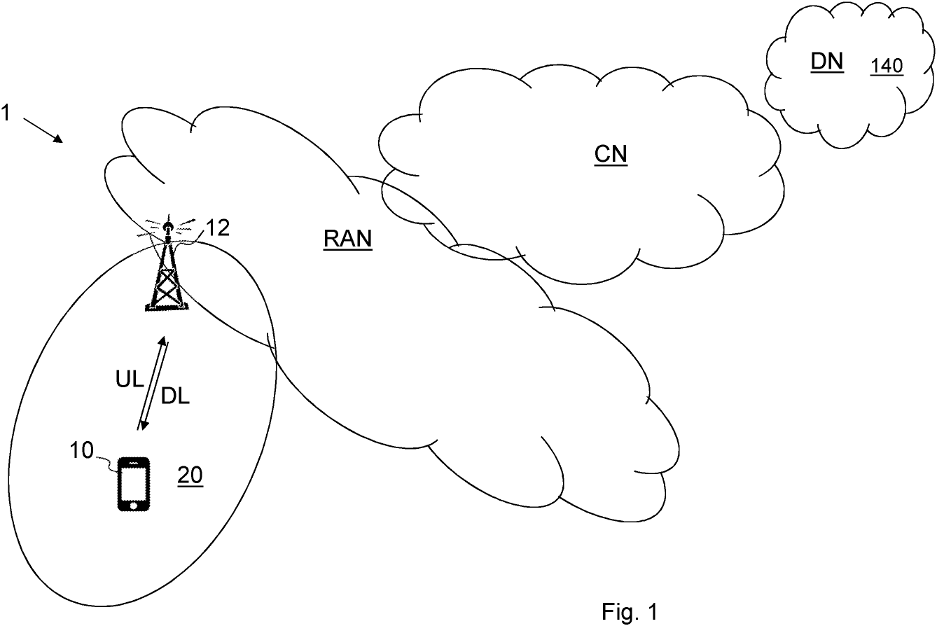

Embodiments herein relate to wireless communications networks in general. FIG. 1 is a schematic overview depicting a wireless communications network, such as a wireless communications network 1. The wireless communications network 1 comprises one or more Radio Access Networks (RANs) and one or more Core Networks (CNs) and the following examples involve just one RAN associated with one CN for simplicity, although the embodiments herein are not limited in this respect. The wireless communications network 1 may use one or a number of different technologies for communication. Embodiments herein relate to recent technology trends that are of particular interest in a New Radio (NR) context, however, embodiments are also applicable in further development of existing wireless communications systems such as e.g. LTE or Wideband Code Division Multiple Access (WCDMA).

In the wireless communications network 1, a wireless device, such as a UE 10, is present. The UE 10 may be a mobile station, a non-access point (non-AP) station (STA), a STA and/or a wireless terminal, communicating via e.g. one or more Access Networks (ANs), e.g. RANs, to one or more CNs. It should be understood by the skilled in the art that “UE” is a non-limiting term which means any terminal, wireless communications terminal, user equipment, Narrowband Internet of Things (NB-loT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communication network 1 comprises a network node 12 providing radio coverage over a geographical area, a service area, e.g. a radio coverage area 20 such as a cell, of a RAT, such as NR, LTE or similar. The network node 12 may provide a transmission point and a reception point, and may be implemented as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the network node 12, depending e.g. on the RAT and terminology used. The network node 12 may be referred to as a serving radio network node wherein the service area may be referred to as a serving cell, and the serving network node communicates with the wireless device in form of downlink (DL) transmissions to the wireless device and uplink (UL) transmissions from the wireless device. It should be noted that a service area may be denoted as cell, beam, beam group or similar to define an area of radio coverage.

Methods and actions according to embodiments herein may for example be performed by the network node 12 or the UE 10, respectively. As an alternative, a Distributed Node (DN) and functionality, e.g. comprised in a cloud 140 as shown in FIG. 1 may be used for performing or partly performing the methods and actions described herein.

According to embodiments herein the network node 12 detects that a non-degradation event has occurred, stores information about the event in a server and transmits an indication of the event. The UE 10 can then retrieve the information about the event from the server and notify the user of the UE about the event if the obtained UE position is within a pre-determined distance from the location of the event.

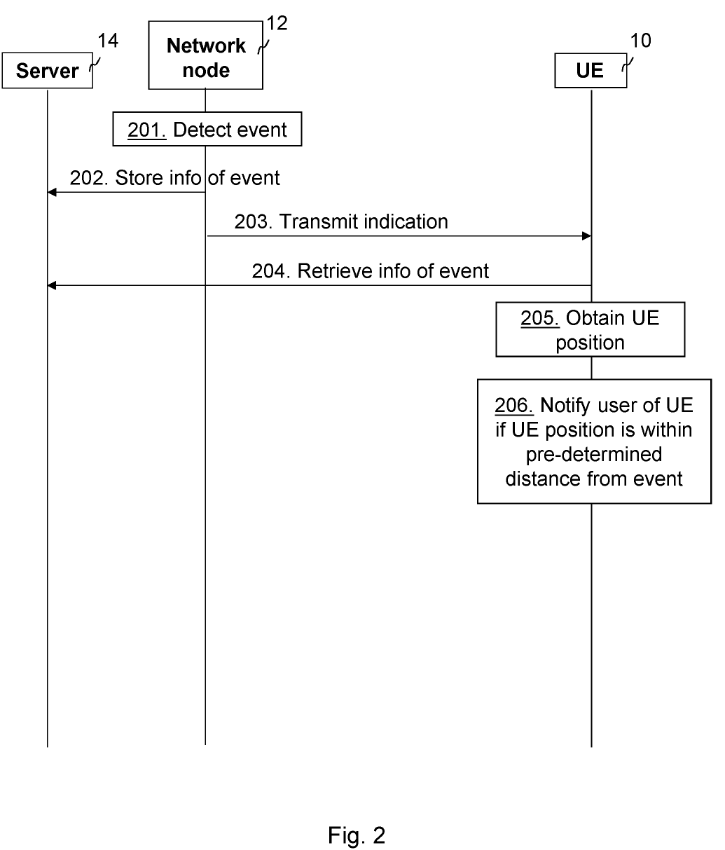

FIG. 2 is a combined signaling scheme and flowchart depicting some embodiments herein.

Action 201. The network node 12 detects that an event 15 associated with a non-radio degradation has occurred in the radio coverage area 20 served by the network node 12. The event may e.g. be a fire, a traffic jam, spreading of virus or decease, etc., which UE 10 users potentially want to avoid, implying basically that the user wants to avoid entering or staying in an area where the user might be affected by the event. The detecting may be based on measurements and observations made by UEs, various detectors and/or sensors in the radio coverage area 20. The detecting may also be based on reports or registrations made by humans. The embodiments herein are not limited to any specific ways of detecting an event that is potentially desirable for UE users to avoid.

Action 202. The network node 12 then stores information about the detected event 15 in a server 14. The information comprises at least a location of the event 15. The location of the event may be a position in a geographic map such as e.g. a google map, building map, shopping mall map, or environment type such as a park, office area or subway. The location of the event 15 may be defined in terms of geographic coordinates or other suitable reference to a location or position. The stored information may further comprise characteristics of the event 15 such as type and magnitude of the event 15.

Action 203. The network node 12 then transmits an indication of the event 15, wherein the indication indicates that said information is available in the server 14 as stored by the network node 12 in action 202. The indication may be transmitted as a broadcast, a multicast or a unicast. The purpose of transmitting the indication may be to instruct one or more UEs 10 in the radio coverage area 20 to retrieve said information from the server 14 as a basis for deciding whether the UE user should be notified about the event 15 or not.

Action 204. After receiving the indication of the event 15 as of action 203, the UE 10 retrieves the information about the event 15, comprising at least the location of the event 15, from the server 14.

Action 205. In order to determine whether the UE 10 is close to the event 15, the UE 10 then obtains the position of the UE 10.

Action 206. If the obtained position of the UE 10 is within a pre-determined distance or range from the location of the event 15, the UE 10 notifies the user of the UE 10 about the event 15. Else, if the obtained position of the UE 10 is not within the pre-determined distance or range from the location of the event 15, the UE may refrain from notifying the user of the UE 10 of the event 15.

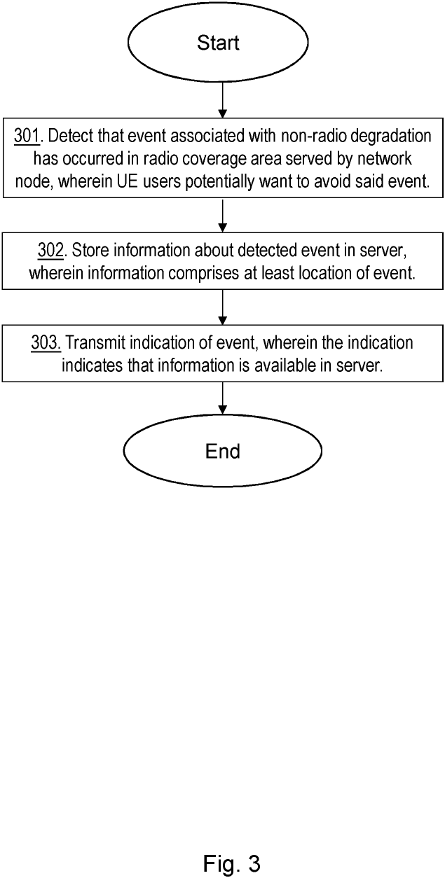

Some actions that may be performed by the network node 12 for enabling notifications to UE 10 users according to embodiments herein will now be described with reference to a flowchart depicted in FIG. 3. The actions do not have to be taken in the order stated below, but may be taken in any suitable order.

Action 301. The network node 12 detects that the event 15 associated with a non-radio degradation has occurred in the radio coverage area 20 served by the network node 12, wherein the UE 10 users potentially want to avoid said event 15.

The detecting in action 301 may be based on measurements and observations made by one or more suitable detectors and/or sensors in the radio coverage area 20 which could for example be implemented and carried by UEs which are operable to report their measurements and observations to the network.

Action 302. The network node 12 then stores information about the detected event 15 in the server 14, wherein the information comprises at least the location of the event 15.

The location of the event 15 may be a position in a geographic map, such as a google map, building map, shopping mall map, city or block map, or environment type such as a park, office area or subway.

In some embodiments, the stored information may further comprise characteristics of the event 15, such as type and magnitude of the event 15.

Action 303. The network node 12 transmits the indication of the event 15, wherein the indication indicates that said information is available in the server 14.

In some embodiments, the indication may be transmitted as broadcast, multicast or unicast.

The indication may instruct one or more UEs 10 in the radio coverage area 20 to retrieve said information from the server 14 as a basis for deciding whether a UE user should be notified about the event 15 or not.

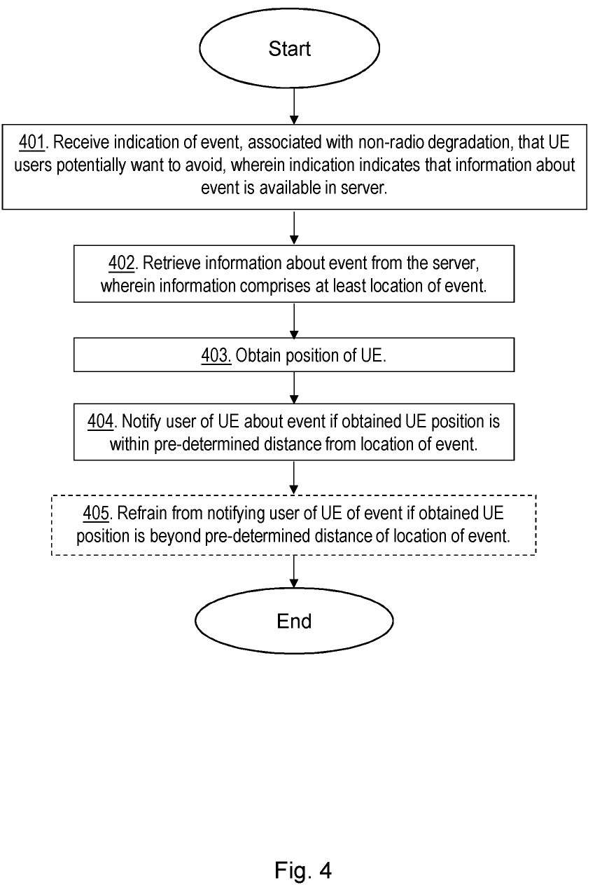

Some actions that may be performed by the UE 10 for enabling notifications to UE 10 users according to embodiments herein will now be described with reference to a flowchart depicted in FIG. 4. The actions do not have to be taken in the order stated below, but may be taken in any suitable order. Optional actions that may be performed in some embodiments are marked with dashed boxes.

Action 401. The UE 10 receives the indication of the event 15, associated with a non-radio degradation, which the UE 10 users potentially want to avoid, wherein the indication indicates that information about the event 15 is available in the server 14.

The indication may be received as broadcast, multicast or unicast from the network node 12, serving the radio coverage area 20 in which the event 15 has occurred.

In some embodiments, the UE 10 may be instructed by the indication to retrieve said information from the server 14 as a basis for deciding whether the UE user should be notified about the event 15 or not.

Action 402. The UE 10 retrieves the information about the event 15 from the server 14, wherein the information comprises at least the location of the event 15.

In some embodiments, the information further comprises characteristics of the event 15 such as type and magnitude of the event 15.

The location of the event 15 may be a position in the geographic map.

Action 403. The UE 10 obtains the position of the UE 10.

Action 404. The UE 10 then notifies the user of the UE 10 about the event 15 if the obtained UE 10 position is within a pre-determined distance or range from the location of the event 15.

Action 405. In some embodiments, the UE 10 may refrain from notifying the user of the UE 10 of the event 15, if the obtained UE 10 position is beyond the pre-determined distance of the location of the event 15.

Some of the embodiments herein, as mentioned above, will now be further described and exemplified. The text below is applicable to and may be combined with any suitable embodiment(s) described above.

An example of some embodiments may comprise at least some of the following activities:
Once any event 15 associated with non-radio degradation occurs in the network, the information, mainly the location of the event 15 as well as the type of the degradation, may be stored in a remote server 14 accessible by UEs 10 in the network.
The impact of the event targets the UE users, e.g. subscribers. For that purpose as a prerequisite, a mobile application may be downloaded in virtually all UEs operating in the network.
A compact parameter, e.g. coded in two bits which gives four options, may be added to the existing wireless standards, e.g. 3GPP 36.331. One option of the parameter may be to inform the UE 10 whether there is an event 15 associated with non-radio degradation or not. The parameter may be broadcasted over the air interface and hence all UE 10, whether in idle or in connected mode, will receive that parameter at any time.
In case the occurrence of the event associated with non-radio degradation is broadcasted, the UE 10 in idle mode may take the following two actions:
   Move to connected mode; and
   Launch the already installed mobile application in order to connect to a remote server 14 where all events 15 associated with non-radio degradation are stored. Then the UE 10 may collect all information, including the location of the event 15, stored about the latest event 15.
The UE 10 may obtain its position, e.g. calculate its location, to compare it with the location of the event 15. If the UE 10 is located close to the event 15, e.g. within a pre-determined distance or radius or within a polygon given by the location of the event 15, it may in some examples be pre-determined how the proximity to the location of the event 15 is determined and in some examples the proximity may be configurable e.g. by configuring a distance threshold or the like, to determine whether the UE 10 is close or far from the location of the event 15. Then a mobile application in the UE, e.g. downloaded by the subscriber from an operator server, may show further degradation details, e.g. in a text format to the UE 10 user that it is a fire in building1 of road1 in city1, etc. Otherwise if the UE 10 is not located inside the area of degradation, then the application may not show the degradation message to the UE 10 user as the UE 10 user is not likely to be affected thus making the degradation message irrelevant to the user. In some further examples, once the UE 10 determines that the degradation information is not relevant, it may refrain from contacting the remote server 14 for a certain time and/or until the UE 10 is made aware that a new event 15 has occurred or the event 15 information has been updated, e.g., area X may change or the criticality of the event 15 may change.
An advantage with embodiments herein is enabling of resource-efficient UE-controlled handling of non-radio degradation information, e.g. related to local destructions, a fire or a traffic jam, where only the UE 10 users that might be affected by the non-radio degradation event are notified about the non-radio degradation while other non-affected users are not informed. Another advantage is that the relevance of notifications about non-radio degradation events to users will increase by knowing that irrelevant notifications are not transmitted.

Some of the embodiments herein, as mentioned above, will now be further described below with reference to the following two procedures:
A first procedure 1-1 comprises detecting and reporting, to a dedicated entity such as a suitable server in the network, any non-radio degradation event 15 that occurs in the wireless network.
A second procedure 1-2 comprises notifying only the UE users that are close geographically to the location of the non-radio degradation event 15.

The first procedure 1-1 and second procedure 1-2 will now be explained in more detail below.

First procedure 1-1, to detect and report the non-radio degradation, comprises two scenarios:
Scenario 1: Non-radio degradation detected by specific sensors and detectors which may be embedded in various UEs such as the UE 10. A UE that detects a non-radio degradation event may be referred to as a “detecting UE” which term is used below. This scenario can be executed in two phases:
   Detecting the degradation: The detecting UE may be equipped with any type of ‘non radio’ sensor, e.g. a sensor that detects a fire, or surrounding noise or a specific gas, e.g. high level of CO2, etc.
   Reporting the degradation: Then a pre-determined threshold may be set for each type of sensor and if the measurement of the sensor exceeds that threshold then the detecting UE may send a notification to the network. In one example this could be done by the detecting UE notifying the network, e.g. the network node 12, via a wireless signaling message, e.g. RRC radio measurement. In another example the detecting UE may notify the network, in particular the remote server 14, via the mobile application implemented at the detecting UE.
Scenario 2: Non-radio degradation detected at the network node 12, e.g. a traffic jam. This may be done by implementing at the network side, e.g. the network node 12, an entity that detects one or more events 15 associated to non-radio degradation. In one example, a Doppler shift measurement device may be implemented at the network node 12, with the objective is to detect the traffic jam in the surroundings of the network node 12. The detection of the event 15 associated with non-radio degradation may be done in the following phases:
   A learning phase where a learning entity is embedded at the network node 12. It may comprise of learning a movement of vehicles at different location of a cell, at different times of the day and at different days of the week. In one option, the velocity of the detecting UE may be calculated by taking into consideration a Doppler effect on the vehicle itself or on a detecting UE in connected mode, e.g. via formula f d=f*v/c.
   Based on the learning phase above, some predefined velocity thresholds may be defined by an operator. It follows, either the same thresholds are set on all roads or different predefined thresholds are configured for each road. Later, when the velocity of the vehicle becomes less than the threshold, e.g. velocity < threshold1 on one road, then that road is considered as having traffic jam.
   Reporting of the non-radio degradation: After that a dedicated entity, e.g. Doppler effect measurement entity, detects a non-radio degradation, it reports that information to the network node 12, e.g. via an Operations Support System (OSS). The network node 12 may broadcast the information of the event associated with non-radio degradation together with the location of the event 15 to all UEs in the cell.

Second procedure 1-2: Procedure for notifying only the subscribers that are close to the area of degradation comprises two different scenarios:
Scenario 1: All UE 10 users in the cell are notified (prior art method)

This may be done by sending SMS (Short Message Service) to all UEs in the cell, by using existing procedures in prior art. Then each UE 10 user is notified.

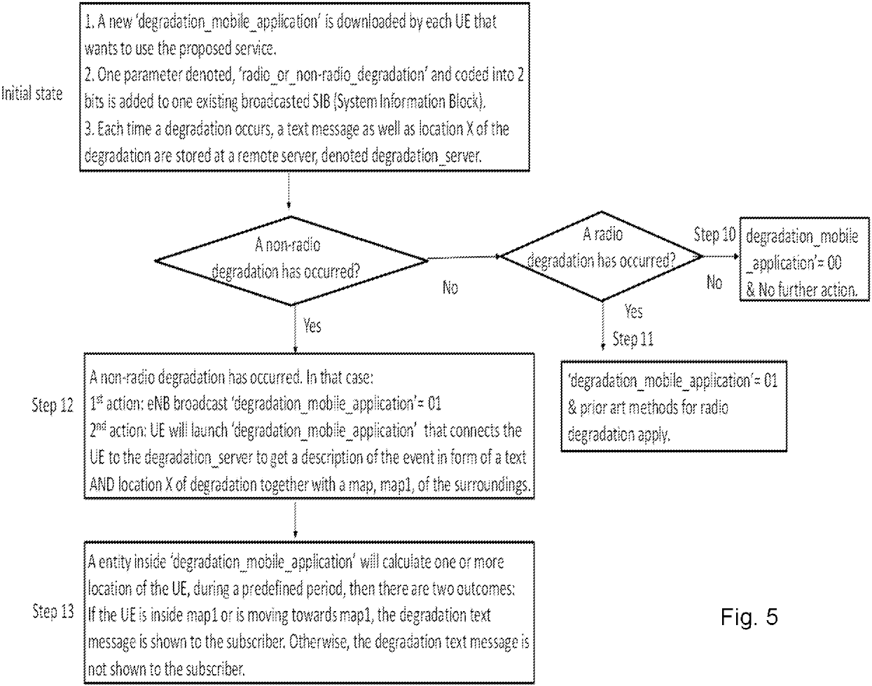

Scenario 2: Only the UE 10 users that are close to the location of the event 15 are notified. The scenario 2 could be performed by using a procedure that comprises the following steps as shown in FIG. 5:

The term “radio degradation”, when used herein, denotes a state or situation when radio communication in an area or location is poor in some sense, meaning that the radio communication between UEs and the RAN is basically not working as required. A radio degradation may be caused by poor signal quality, interference, malfunction of equipment, inadequate settings or configurations in the UE or RAN, insufficient radio resources or capacity, and so forth.

Initial state: Following three prerequisites are required:
Prerequisite 1: A dedicated mobile application, e.g. denoted ‘non-radio_degradation_application’, may be downloaded on the UEs 10 of all subscribers that would like to benefit from this service.
Prerequisite 2: One parameter, e.g. denoted ‘radio_or non-radio_degradation’, and coded in 2 bits, may be broadcasted on cell System Information via one System Information Block (SIB). The parameter ‘radio_or non-radio degradation’ may indicate one of the following three statuses:
   ‘radio_or non-radio degradation’ = 00 (there is no degradation in the cell)
   ‘radio_or non-radio degradation’ = 10 (there is a radio degradation in the cell)
   ‘radio_or non-radio degradation’ = 01 (there is a non-radio degradation in the cell)
   ‘radio_or non-radio degradation’ = 11 (for future use).
Prerequisite 3: A remote server 14, denoted ‘degradation_server’, may be available where, each time a degradation occurs, e.g. each time an event 15 associated with a non-radio degradation occurs, a text message defining the event, e.g. ‘A fire has occurred at building1 in road1 in city1’, is stored. The location X of the event 15 together with a map, map1, having location X of the event 15 as a center and a radius of a size that depends on each type and severity of the event 15, e.g. a fire in a flat may have a radius of 20 meters or 100 meters where a traffic jam issue may have a radius of a few kilometers.

Step 10: If no degradation, neither radio nor non-radio, has occurred, then no further action is taken.

Step 11: If a radio degradation has occurred then prior art methods for radio degradation apply.

Step 12: If a non-radio degradation has occurred, if the received broadcasted parameter ‘radio_or non-radio degradation’ is equal to 01, then the UE 10 may autonomously, without the UE user intervention, trigger the stored application ‘non-radio_degradation_application’ which will have the role to contact the ‘degradation_server’ and get the stored information, e.g. a text message and the map of the surroundings of the degraded area, map1, which includes location X of the event 15. This applies to all UE 10, whether they are in connected or in idle mode. This comes from the fact that all UE 10, with whatever status, may read the broadcasted parameter ‘radio_or_non-radio_degradation’ and may then take the necessary action as described in the following step 13.

Step 13: An entity inside the mobile application may perform the following task:

Obtain, e.g. calculate, one or more UE 10 position, e.g. UE 10 location, to check the position and/or a direction of the UE 10.

If the UE 10 is inside the received map1 or the UE 10 is moving towards the area defined by the map1, then the mobile application may show the received degradation text message, to the UE user.
If the UE 10 is not located inside the map1 or is moving in the opposite direction of map1, then the mobile application may not show the degradation message to the UE user.

As a result, the subscriber may be notified via a text message about the occurrence of the event 15 associated with non-radio degradation only when being inside map1, that is when being in the surroundings of the location of the event 15.

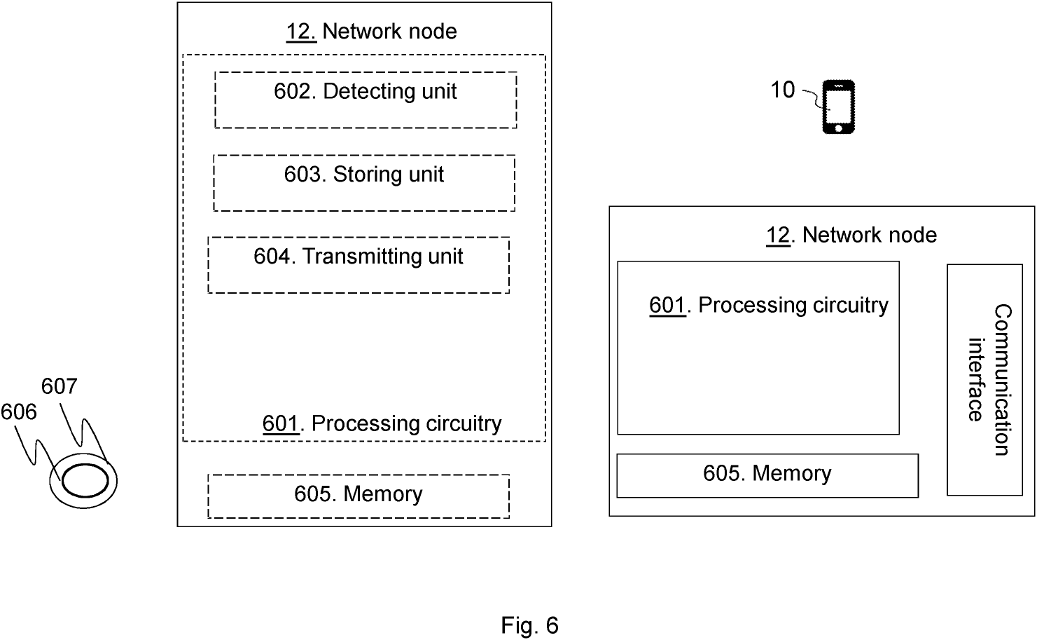

FIG. 6 is a block diagram depicting the network node 12 for enabling notifications to UE 10 users, according to embodiments herein.

The network node 12 may comprise processing circuitry 601, e.g. one or more processors, configured to perform the methods herein.

The network node 12 may comprise a detecting unit 602. The network node 12, the processing circuitry 601, and/or the detecting unit 602 is configured to detect that the event 15 associated with a non-radio degradation has occurred in the radio coverage area 20 served by the network node 12, wherein UE 10 users potentially want to avoid said event 15. The detecting may be adapted to be based on measurements and observations made by UEs and/or sensors in the radio coverage area 20.

The network node 12 may comprise a storing unit 603. The network node 12, the processing circuitry 601, and/or the storing unit 603 is configured to store information about the detected event 15 in the server 14, wherein the information comprises at least the location of the event 15. The location of the event 15 may be a position in a geographic map. The stored information may further comprise characteristics of the event 15 such as type and magnitude of the event 15.

The network node 12 may comprise a transmitting unit 604. The network node 12, the processing circuitry 601, and/or the transmitting unit 604 is configured transmit the indication of the event 15, wherein the indication indicates that said information is available in the server 14. The indication may be adapted to be transmitted as a broadcast, a multicast or a unicast. The indication may be adapted to instruct one or more UEs 10 in the radio coverage area 20 to retrieve said information from the server 14 as a basis for deciding whether a UE user should be notified about the event 15 or not.

The network node 12 further comprises a memory 605. The memory 606 comprises one or more units to be used to store data on, such as event information, non-radio degradation information, measurements and observations made by UEs and/or sensors, input/output data, metadata, etc. and applications to perform the methods disclosed herein when being executed, and similar. The network node 12 may further comprise a communication interface comprising e.g. one or more antenna or antenna elements.

The methods according to the embodiments described herein for the network node 12 are respectively implemented by means of e.g. a computer program product 606 or a computer program, comprising instructions, i.e., software code portions, which, when executed on at least one processor, cause the at least one processor to carry out the actions described herein, as performed by the network node 12. The computer program product 606 may be stored on a computer-readable storage medium 607, e.g. a disc, a universal serial bus (USB) stick or similar. The computer-readable storage medium 607, having stored thereon the computer program product, may comprise the instructions which, when executed on at least one processor, cause the at least one processor to carry out the actions described herein, as performed by the network node 12. In some embodiments, the computer-readable storage medium may be a transitory or a non-transitory computer-readable storage medium.

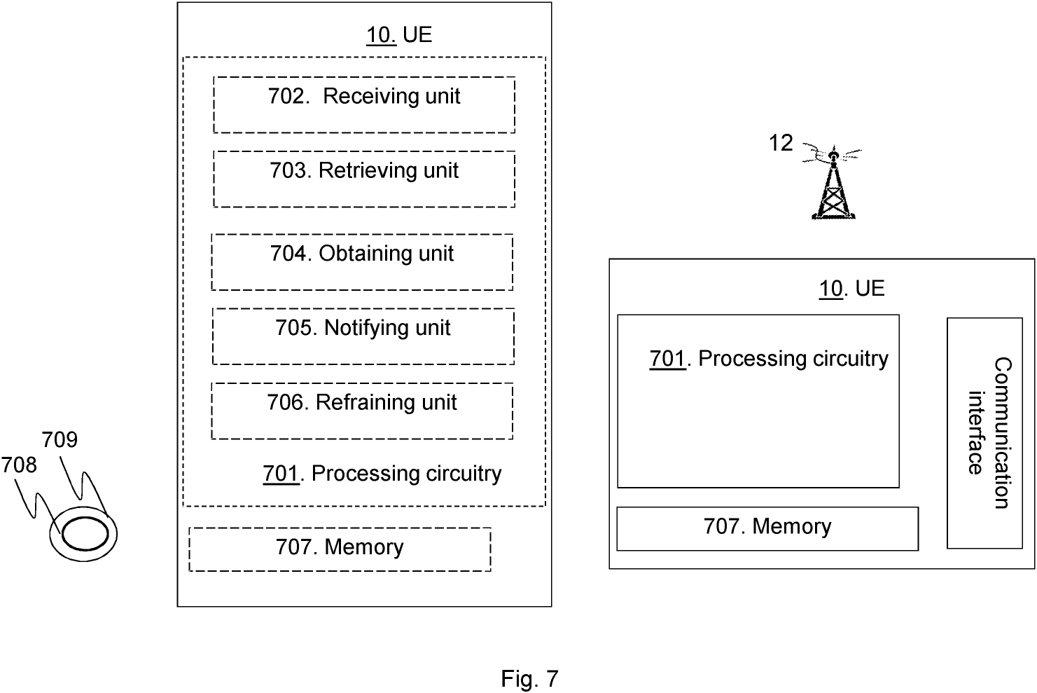

FIG. 7 is a block diagram depicting the UE 10 for enabling notifications to UE 10 users, according to embodiments herein.

The UE 10 may comprise processing circuitry 701, e.g. one or more processors, configured to perform the methods herein.

The UE 10 may comprise a receiving unit 702. The UE 10, the processing circuitry 701, and/or the receiving unit 702 is configured to receive the indication of the event 15, associated with a non-radio degradation, which the UE 10 users potentially want to avoid, wherein the indication indicates that information about the event is available in the server 14. The indication may be adapted to be received as a broadcast, a multicast or a unicast from the network node 12 serving the radio coverage area 20 in which the event has occurred. The UE 10 may be instructed by the indication to retrieve said information from the server 14 as basis for deciding whether the UE users should be notified about the event or not.

The UE 10 may comprise a retrieving unit 703. The UE 10, the processing circuitry 701, and/or the retrieving unit 703 is configured to retrieve the information about the event 15 from the server 14, wherein the information comprises at least a location of the event. The location of the event 15 may be a position in the geographic map. The information may further comprise characteristics of the event 15 such as type and magnitude of the event 15.

The UE 10 may comprise an obtaining unit 704. The UE 10, the processing circuitry 701, and/or the obtaining unit 704 is configured to obtain the position of the UE 10.

The UE 10 may comprise a notifying unit 705. The UE 10, the processing circuitry 701, and/or the notifying unit 705 is configured to notify the UE 10 user about the event 15 if the obtained UE 10 position is within the pre-determined distance from the location of the event 15.

The UE 10 may comprise a refraining unit 706. The UE 10, the processing circuitry 701, and/or the refraining unit 706 may be configured to refrain from notifying the UE 10 users of the event 15 if the obtained UE 10 position is beyond the pre-determined distance of the location of the event 15.

The UE 10 further comprises a memory 707. The memory 707 comprises one or more units to be used to store data on, such as event information, non-radio degradation information, measurements and observations made by UEs and/or sensors, input/output data, metadata, etc. and applications to perform the methods disclosed herein when being executed, and similar. The UE 10 may further comprise a communication interface comprising e.g. one or more antenna or antenna elements.

The methods according to the embodiments described herein for the UE 10 are respectively implemented by means of e.g. a computer program product 708 or a computer program, comprising instructions, i.e., software code portions, which, when executed on at least one processor, cause the at least one processor to carry out the actions described herein, as performed by the UE 10. The computer program product 708 may be stored on a computer-readable storage medium 709, e.g. a disc, a universal serial bus (USB) stick or similar. The computer-readable storage medium 709, having stored thereon the computer program product, may comprise the instructions which, when executed on at least one processor, cause the at least one processor to carry out the actions described herein, as performed by the UE 10. In some embodiments, the computer-readable storage medium may be a transitory or a non-transitory computer-readable storage medium.

In some embodiments a more general term “network node” is used and it can correspond to any type of radio-network node or any network node, which communicates with a wireless device and/or with another network node. Examples of network nodes are gNodeB, eNodeB, NodeB, MeNB, SeNB, a network node belonging to Master cell group (MCG) or Secondary cell group (SCG), base station (BS), multi-standard radio (MSR) radio node such as MSR BS, eNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any radio access technology (RAT) or multi-RAT systems, where the devices receives and/or transmit signals, e.g. data, such as New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a UE or network node, for example.

Alternatively, several of the functional elements of the processing units discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

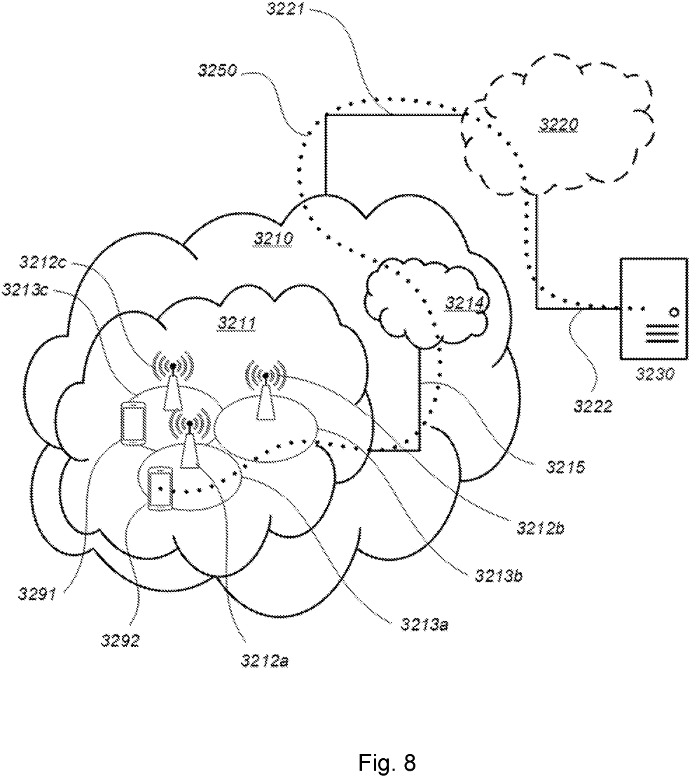

FIG. 8 shows a Telecommunication network connected via an intermediate network to a host computer in accordance with some embodiments. With reference to FIG. 8, in accordance with an embodiment, a communication system includes telecommunication network 3210, such as a 3GPP-type cellular network, which comprises access network 3211, such as a radio access network, and core network 3214. Access network 3211 comprises a plurality of base stations 3212a, 3212b, 3212c, such as NBs, eNBs, gNBs or other types of wireless access points being examples of the radio network node 12 above, each defining a corresponding coverage area 3213a, 3213b, 3213c. Each base station 3212a, 3212b, 3212c is connectable to core network 3214 over a wired or wireless connection 3215. A first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example being examples of the wireless device 10 above, the disclosed embodiments are equally applicable to a situation where a sole UE is in the coverage area or where a sole UE is connecting to the corresponding base station 3212.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 8 as a whole enables connectivity between the connected UEs 3291, 3292 and host computer 3230. The connectivity may be described as an over-the-top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. For example, base station 3212 may not or need not be informed about the past routing of an incoming downlink communication with data originating from host computer 3230 to be forwarded (e.g., handed over) to a connected UE 3291. Similarly, base station 3212 need not be aware of the future routing of an outgoing uplink communication originating from the UE 3291 towards the host computer 3230.

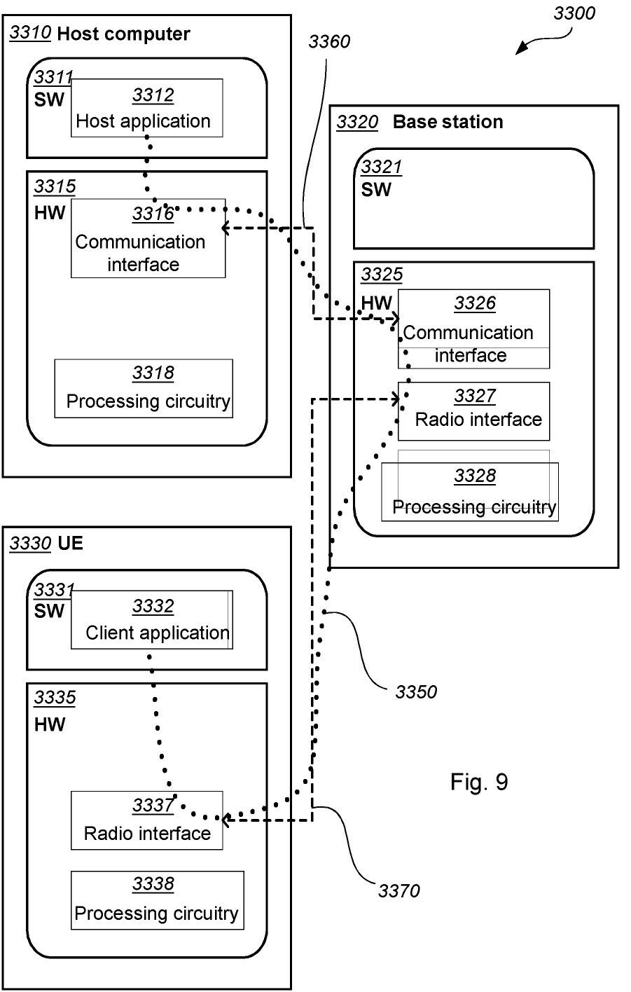

FIG. 9 shows a host computer communicating via a base station and with a user equipment over a partially wireless connection in accordance with some embodiments

Example implementations, in accordance with an embodiment, of the UE, base station and host computer discussed in the preceding paragraphs will now be described with reference to FIG. 9. In communication system 3300, host computer 3310 comprises hardware 3315 including communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, application-specific integrated circuits, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 further includes base station 3320 provided in a telecommunication system and comprising hardware 3325 enabling it to communicate with host computer 3310 and with UE 3330. Hardware 3325 may include communication interface 3326 for setting up and maintaining a wired or wireless connection with an interface of a different communication device of communication system 3300, as well as radio interface 3327 for setting up and maintaining at least wireless connection 3370 with UE 3330 located in a coverage area (not shown in FIG. 9) served by base station 3320. Communication interface 3326 may be configured to facilitate connection 3360 to host computer 3310. Connection 3360 may be direct or it may pass through a core network (not shown in FIG. 9) of the telecommunication system and/or through one or more intermediate networks outside the telecommunication system. In the embodiment shown, hardware 3325 of base station 3320 further includes processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 further includes UE 3330 already referred to. Its hardware 3333 may include radio interface 3337 configured to set up and maintain wireless connection 3370 with a base station serving a coverage area in which UE 3330 is currently located. Hardware 3333 of UE 3330 further includes processing circuitry 3338, which may comprise one or more programmable processors, application-specific integrated circuits, field programmable gate arrays or combinations of these (not shown) adapted to execute instructions. UE 3330 further comprises software 3331, which is stored in or accessible by UE 3330 and executable by processing circuitry 3338. Software 3331 includes client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 9 may be similar or identical to host computer 3230, one of base stations 3212a, 3212b, 3212c and one of UEs 3291, 3292 of FIG. 8, respectively. This is to say, the inner workings of these entities may be as shown in FIG. 9 and independently, the surrounding network topology may be that of FIG. 8.

In FIG. 9, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing (e.g., on the basis of load balancing consideration or reconfiguration of the network).

Wireless connection 3370 between UE 3330 and base station 3320 is in accordance with the teachings of the embodiments described throughout this disclosure. One or more of the various embodiments improve the performance of OTT services provided to UE 3330 using OTT connection 3350, in which wireless connection 3370 forms the last segment. More precisely, the teachings of these embodiments may increase the performance of the UE as only the affected UE are notified about the event. This improves the UE battery life time and the overall network signalling overhead.

A measurement procedure may be provided for the purpose of monitoring data rate, latency and other factors on which the one or more embodiments improve. There may further be an optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3333 of UE 3330, or both. In embodiments, sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. In certain embodiments, measurements may involve proprietary UE signaling facilitating host computer 3310′s measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

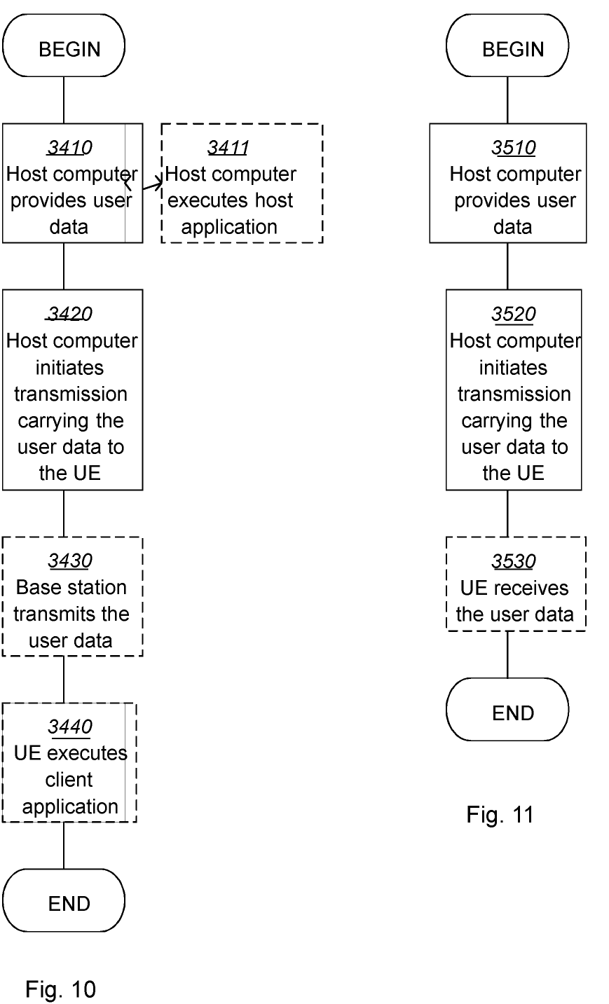

FIG. 10 shows methods implemented in a communication system including a host computer, a base station and a user equipment in accordance with some embodiments.

FIG. 10 is a flowchart illustrating a method implemented in a communication system, in accordance with one embodiment. The communication system includes a host computer, a base station and a UE which may be those described with reference to FIG. 8 and FIG. 9. For simplicity of the present disclosure, only drawing references to FIG. 10 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated, in accordance with the teachings of the embodiments described throughout this disclosure. In step 3440 (which may also be optional), the UE executes a client application associated with the host application executed by the host computer.

FIG. 11 shows methods implemented in a communication system including a host computer, a base station and a user equipment in accordance with some embodiments.

FIG. 11 is a flowchart illustrating a method implemented in a communication system, in accordance with one embodiment. The communication system includes a host computer, a base station and a UE which may be those described with reference to FIG. 8 and FIG. 9. For simplicity of the present disclosure, only drawing references to FIG. 11 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station, in accordance with the teachings of the embodiments described throughout this disclosure. In step 3530 (which may be optional), the UE receives the user data carried in the transmission.

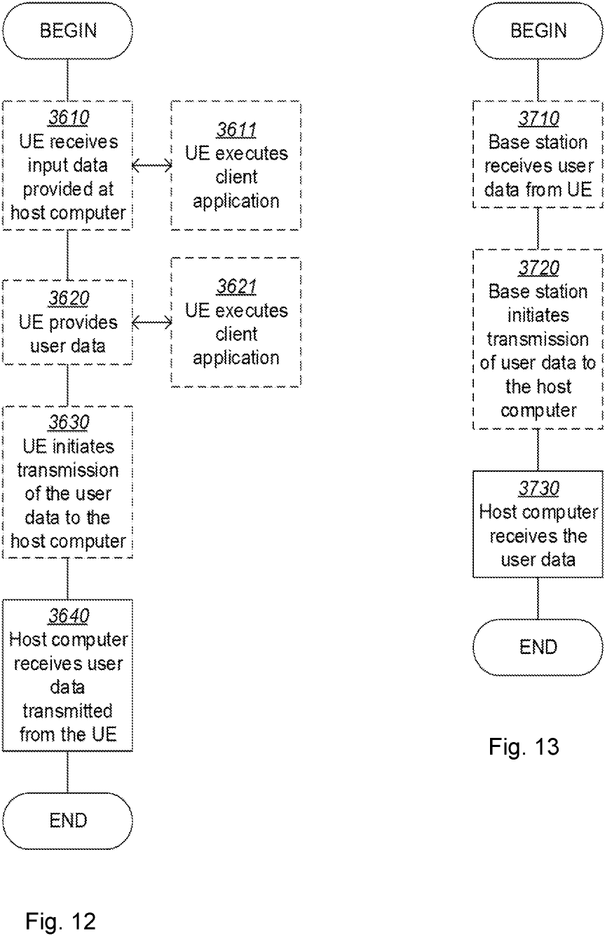

FIG. 12 shows methods implemented in a communication system including a host computer, a base station and a user equipment in accordance with some embodiments.

FIG. 12 is a flowchart illustrating a method implemented in a communication system, in accordance with one embodiment. The communication system includes a host computer, a base station and a UE which may be those described with reference to FIG. 8 and FIG. 9. For simplicity of the present disclosure, only drawing references to FIG. 12 will be included in this section. In step 3610 (which may be optional), the UE receives input data provided by the host computer. Additionally or alternatively, in step 3620, the UE provides user data. In substep 3621 (which may be optional) of step 3620, the UE provides the user data by executing a client application. In substep 3611 (which may be optional) of step 3610, the UE executes a client application which provides the user data in reaction to the received input data provided by the host computer. In providing the user data, the executed client application may further consider user input received from the user. Regardless of the specific manner in which the user data was provided, the UE initiates, in substep 3630 (which may be optional), transmission of the user data to the host computer. In step 3640 of the method, the host computer receives the user data transmitted from the UE, in accordance with the teachings of the embodiments described throughout this disclosure.

FIG. 13 show methods implemented in a communication system including a host computer, a base station and a user equipment in accordance with some embodiments.

FIG. 13 is a flowchart illustrating a method implemented in a communication system, in accordance with one embodiment. The communication system includes a host computer, a base station and a UE which may be those described with reference to FIG. 8 and FIG. 9. For simplicity of the present disclosure, only drawing references to FIG. 13 will be included in this section. In step 3710 (which may be optional), in accordance with the teachings of the embodiments described throughout this disclosure, the base station receives user data from the UE. In step 3720 (which may be optional), the base station initiates transmission of the received user data to the host computer. In step 3730 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by at least one network node for enabling notifications to User Equipment, UE, users, wherein the method comprises:
detecting that an event associated with a non-radio degradation has occurred in a radio coverage area served by the network node, wherein the UE users potentially want to avoid said event;
storing information about the detected event in a server, wherein the information comprises at least a location of the event; and
transmitting an indication of the event, wherein the indication indicates that said information is available in the server, and wherein the indication instructs one or more UEs in the radio coverage area to retrieve said information from the server as a basis for deciding whether a UE user should be notified about the event or not.

2. The method according to claim 1, wherein the indication is transmitted as a broadcast, a multicast or a unicast.

3. The method according to claim 1, wherein the detecting is based on measurements and observations made by UEs and/or sensors in the radio coverage area.

4. The method according to claim 1, wherein the location of the event is a position in a geographic map.

5. The method according to claim 1, wherein the stored information further comprises characteristics of the event such as type and magnitude of the event.

6. (canceled)

7. A method performed by a User Equipment, UE, for enabling notifications to UE users, wherein the method comprises:
receiving an indication of an event, associated with a non-radio degradation, that the UE users potentially want to avoid, wherein the indication indicates that information about the event is available in a server;
retrieving the information about the event from the server, wherein the information comprises at least a location of the event;
obtaining a position of the UE; and
notifying the user of the UE about the event if the obtained UE position is within a pre-determined distance from the location of the event, wherein the UE is instructed by the indication to retrieve said information from the server as a basis for deciding whether the UE user should be notified about the event or not.

8. The method according to claim 7, further comprising:
refraining from notifying the user of the UE of the event if the obtained UE position is beyond the pre-determined distance of the location of the event.

9. The method according to claim 7, wherein the indication is received as a broadcast, a multicast or a unicast from a network node serving a radio coverage area in which the event has occurred.

10. The method according to claim 7, wherein the location of the event is a position in a geographic map.

11. The method according to claim 7, wherein the information further comprises characteristics of the event such as type and magnitude of the event.

12. (canceled)

13. A network node for enabling notifications to User Equipment, UE, users, wherein the network node is configured to:
detect that an event associated with a non-radio degradation has occurred in a radio coverage area served by the network node, wherein UE users potentially want to avoid said event;
store information about the detected event in a server, wherein the information comprises at least a location of the event; and
transmit an indication of the event, wherein the indication indicates that said information is available in the server, wherein the indication is adapted to instruct one or more UEs in the radio coverage area to retrieve said information from the server as a basis for deciding whether a UE user should be notified about the event or not.

14. The network node according to claim 13, wherein the indication is adapted to be transmitted as a broadcast, a multicast or a unicast.

15. The network node according to claim 13, wherein the detecting is adapted to be based on measurements and observations made by UEs and/or sensors in the radio coverage area.

16-18. (canceled)

19. A User Equipment, UE, for enabling notifications to UE users, wherein the UE is configured to:
receive an indication of an event, associated with a non-radio degradation, that the UE users potentially want to avoid, wherein the indication indicates that information about the event is available in a server;
retrieve the information about the event from the server, wherein the information comprises at least a location of the event;
obtain a position of the UE; and
notify the UE user about the event if the obtained UE position is within a pre-determined distance from the location of the event, wherein the UE is instructed by the indication to retrieve said information from the server as a basis for deciding whether the UE users should be notified about the event or not.

20. The UE according to claim 19, is further configured to:
refrain from notifying the UE users of the event if the obtained UE position is beyond the pre-determined distance of the location of the event.

21-26. (canceled)
